(19) United States
(12) Patent Application Publication
(10) Pub. No.: US 2017/0047048 A1
(43) Pub. Date: Feb. 16, 2017

(54) METHOD AND APPARATUS FOR ADJUSTING DISPLAY SETTINGS OF A DISPLAY ACCORDING TO AMBIENT LIGHTING

(71) Applicant: THOMSON LICENSING, Issy de Moulineaux (FR)

(72) Inventors: Mark Francis RUMREICH, Indianapolis, IN (US); Regine Jeanne SYDA-LAWTON, Newhall, CA (US); Joel Mitchell FOGELSON, Pasadena, CA (US)

(21) Appl. No.: 15/306,150

(22) PCT Filed: May 6, 2015
(86) PCT No.: PCT/US15/29397

§ 371 Date: Oct. 24, 2016

Related U.S. Application Data
(60) Provisional application No. 61/990,719, filed on May 9, 2014.

(51) Int. Cl. G09G 5/10; G09G 3/20

(52) U.S. Cl. CPC G09G 5/10; G09G 3/2003; G09G 2320/0626; G09G 2320/0606; G09G 2320/0666; G09G 2360/144

(57) ABSTRACT

A method for adjusting a display setting of a display is disclosed. The method comprises detecting an ambient lighting condition; determining whether a stored display setting corresponding to the detected ambient lighting condition exists in a memory; if the corresponding stored display Detecting a condition of ambient setting does not exist, requesting a user entry of a display setting as the corresponding stored display setting; and adjusting the display setting of the display according to the corresponding stored display setting.

### BACKGROUND OF THE INVENTION

Field of the Invention

The present principles of the embodiments generally relate to a method and apparatus for allowing a user to enter display settings for a plurality of different ambient lighting conditions.

Background Information

The display setting of a television has a tremendous effect on how well the television performs. The best television on the market with an incorrect setup almost always looks worse than a mediocre television setup well. However, with the same display setting, a viewer may perceive a displayed image differently with different ambient lightings. For example, a television looks good in the store but may be disappointing when viewed at home because the ambient lighting conditions are different. Although technology for automatically adjusting the image conditions of brightness, contrast, and color temperature of a display such as a television set or computer monitor according to ambient luminance and color temperature is known, the technology does not give user sufficient opportunity to select display settings. Furthermore, conventional techniques using ambient lighting condition are insufficient to correctly reflect the ambient light conditions that in combination affect perceived color quality. As such, the automatic adjustment for better viewing is quite limited.

Accordingly, there is a need for better detection of the ambient lighting condition and for giving a user a chance to enter the best display settings of a television for different ambient lighting conditions.

### SUMMARY OF THE INVENTION

In accordance with an aspect of the present invention, a method for adjusting a display setting of a display is disclosed. The method comprises detecting an ambient lighting condition; determining whether a stored display setting corresponding to the detected ambient lighting condition exists in a memory; if the corresponding stored display setting does not exist, requesting a user entry of a display setting as the corresponding stored display setting; and adjusting the display setting of the display according to the corresponding stored display setting.

In one embodiment, the method further comprises storing the entered display setting in the memory as the corresponding stored display setting.

In another embodiment, the detected ambient lighting condition includes temperature and luminous intensity. The detected ambient lighting condition may include an ambient lighting condition collected at a back side of the display and an ambient lighting condition collected at a front side of the display.

In another embodiment, the detected ambient lighting condition further includes on/off status of a lamp. The detected ambient lighting condition may include current time.

In yet another embodiment, if the user fails to enter a display setting in response to the requesting step, the method further comprises setting automatically by an electronic device a display setting according to a predefined rule as the corresponding stored display setting. The automatically set display setting may not be stored in the memory as the corresponding stored display setting and is used to adjust the display setting of the display. The predefined rule may be using a default display setting as the corresponding stored display setting. In another embodiment, the detected ambient lighting condition includes condition collected at a front side of the display, the lighting condition collected at the front side includes first color temperature, and the predefined rule is to use a display setting having color temperature similar to the first color temperature as the corresponding stored display setting.

In yet another embodiment, the requesting step comprises displaying an on-screen display menu for the user to enter the display setting. The on-screen display menu may include a default display setting.

In accordance with another aspect of the present invention, an electronic device is disclosed. The electronic device comprises a detector configured to detect an ambient lighting condition; a processor configured to determine whether a stored display setting corresponding to the detected ambient lighting condition exists in a memory; wherein if the corresponding stored display setting does not exist, the processor is configured to request a user entry of a display setting as the corresponding stored display setting; and wherein the processor is configured to adjust the display setting of a display according to the corresponding stored display setting.

In one embodiment, the processor is configured to store the entered display setting in the memory as the corresponding stored display setting.

In another embodiment, the detected ambient lighting condition includes temperature and luminous intensity. The detected ambient lighting condition may include an ambient lighting condition collected at a back side of the display and an ambient lighting condition collected at a front side of the display and wherein the detecting means includes rear and front cameras for respectively collecting lighting conditions at the rear and front sides of the display.

In another embodiment, the detected ambient lighting condition further includes on/off status of a lamp. The detected ambient lighting condition may include current time.

In yet another embodiment, if the user fails to enter display setting in response to the requesting step, the processor is configured to automatically set display setting according to a predefined rule as the corresponding stored display setting. The automatically set display setting may not be stored in the memory as the corresponding stored display setting and the processor is configured to adjust the display setting of the display using the automatically set display setting. The predefined rule may be using a default display setting as the corresponding stored display setting. In another embodiment, the detected ambient lighting condition includes condition collected at a front side of the display, the lighting condition collected at the front side includes first color temperature, and the predefined rule is to use a display setting having color temperature similar to the first color temperature as the corresponding stored display setting.

In yet another embodiment, the processor is configured to request the user to enter a display setting by displaying an on-screen display menu. The on-screen display menu may include a default display setting.

In accordance with another aspect of the present invention, an electronic device is disclosed. The electronic device comprises a means for detecting an ambient lighting condition; a processing means configured to determine whether a stored display setting corresponding to the detected ambient lighting condition exists in a memory; wherein if the corresponding stored display setting does not exist, the processing means is configured to request a user entry of a display setting as the corresponding stored display setting; and wherein the processing means is configured to adjust the display setting of a display according to the corresponding stored display setting.

In one embodiment, the processing means is configured to store the entered display setting in the memory as the corresponding stored display setting.

In another embodiment, the detected ambient lighting condition includes temperature and luminous intensity. The detected ambient lighting condition may include an ambient lighting condition collected at a back side of the display and an ambient lighting condition collected at a front side of the display and wherein the detector includes rear and front cameras for respectively collecting lighting conditions at the rear and front sides of the display.

In another embodiment, the detected ambient lighting condition further includes on/off status of a lamp. The detected ambient lighting condition may include current time.

In yet another embodiment, if the user fails to enter display setting in response to the requesting step, the processing means is configured to automatically set display setting according to a predefined rule as the corresponding stored display setting. The automatically set display setting may not be stored in the memory as the corresponding stored display setting and the processing means is configured to adjust the display setting of the display using the automatically set display setting. The predefined rule may be using a default display setting as the corresponding stored display setting. In another embodiment, the detected ambient lighting condition includes condition collected at a front side of the display, the lighting condition collected at the front side includes first color temperature, and the predefined rule is to use a display setting having color temperature similar to the first color temperature as the corresponding stored display setting.

In yet another embodiment, the processing means is configured to request the user to enter a display setting by displaying an on-screen display menu. The on-screen display menu may include a default display setting.

The aforementioned brief summary of exemplary embodiments of the present invention is merely illustrative of the inventive concepts presented herein, and is not intended to limit the scope of the present invention in any manner.

### DETAILED DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

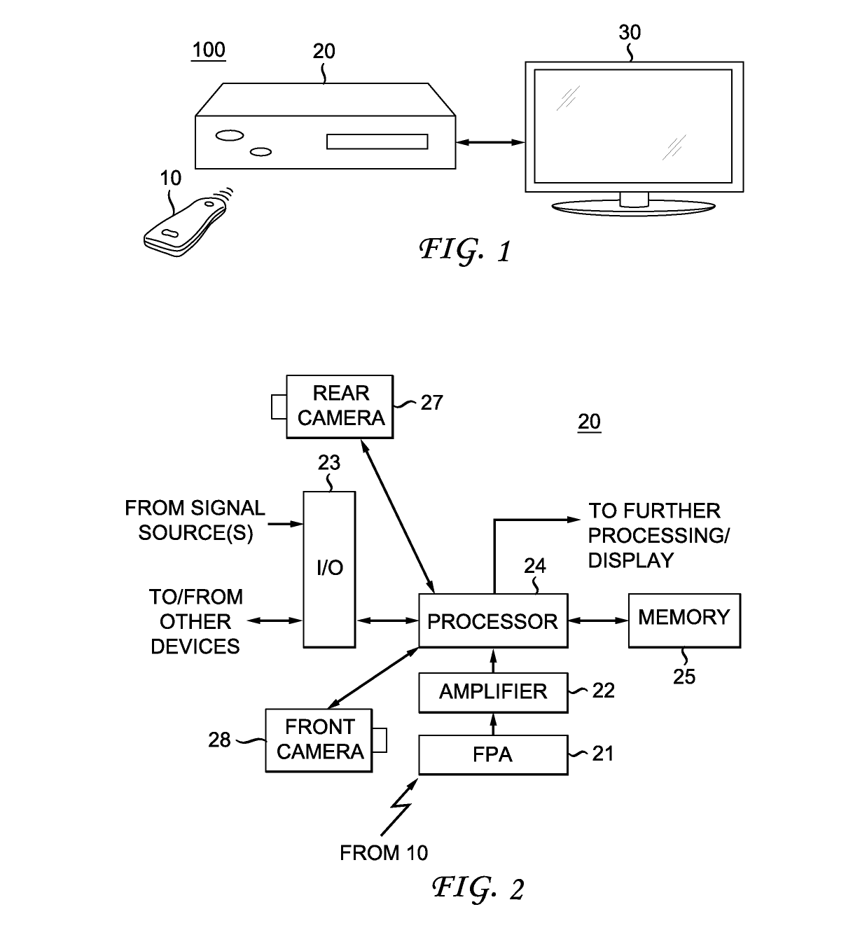

FIG. 1 shows an electronic device according to an exemplary embodiment of the present invention;

FIG. 2 shows a block diagram of the electronic device of FIG. 1 according to an exemplary embodiment of the present invention;

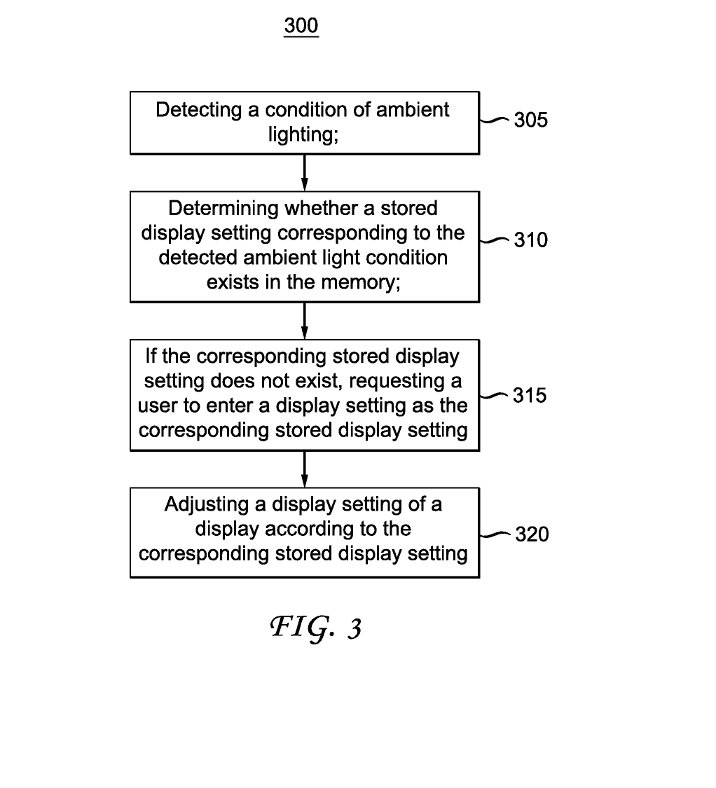

FIG. 3 shows an exemplary process 300 for adjusting display setting of a display according to ambient lighting condition, according to the principles of the embodiments of the invention;

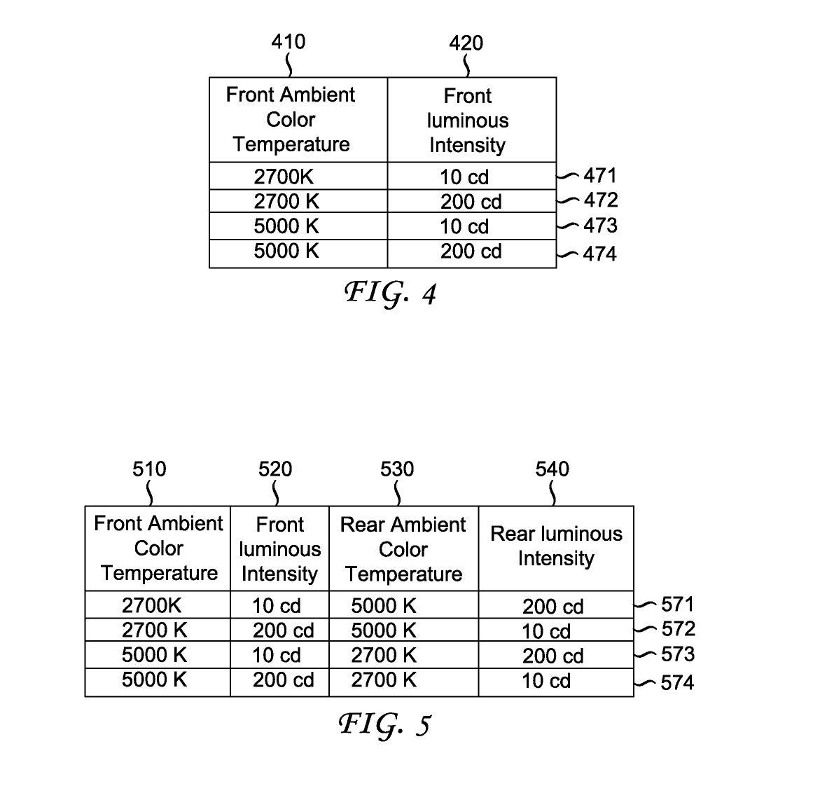

FIG. 4 shows an exemplary ambient lighting condition that includes the front ambient lighting condition;

FIG. 5 shows an exemplary ambient lighting condition that includes the front and rear ambient lighting conditions;

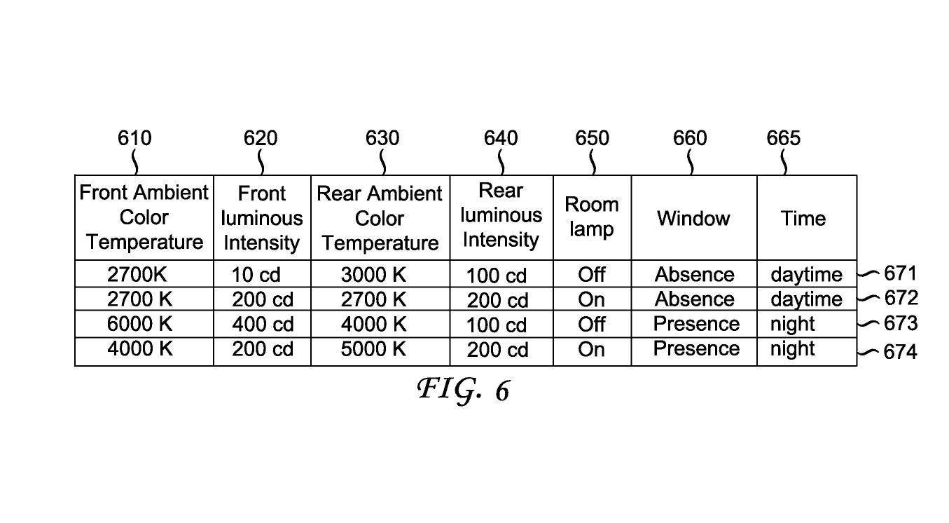

FIG. 6 shows an exemplary ambient lighting condition that includes the front and rear ambient lighting conditions, the room lamp status, a window status, and the time; and

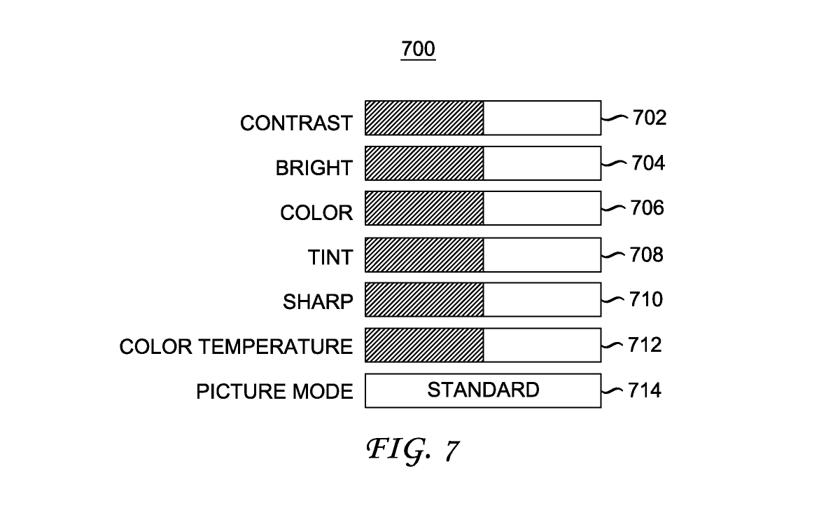

FIG. 7 shows an exemplary menu for a user to enter a display setting.

The exemplifications set out herein illustrate preferred embodiments of the invention, and such exemplifications are not to be construed as limiting the scope of the invention in any manner.

### DETAILED DESCRIPTION

Referring now to the drawings, and more particularly to FIG. 1, an exemplary environment 100 suitable for implementing the present invention is shown. As indicated in FIG. 1, environment 100 comprises a user input device 10, and an electronic device 20 capable of tuning a channel for receiving broadcast signals, decoding the broadcast signals and sending the decoded signals to a display 30 for playback, recording broadcast signals, and playing back recorded broadcast signals or signals recorded in a storage device connected to the electronic device 20, such as but not limited to a CD, a DVD, a Blu-ray disk, a local hard disk, or a network storage. The electronic device 20 can also play back recorded signals from another playback device connected to the electronic device 20. According to an exemplary embodiment, electronic device 20 is embodied as a television signal receiver (e.g., a set-top box, a Video Cassette Recorder (VCR), a personal video recorder (PVR), a hard disk recorder (HDR), a digital video recorder (DVR), a Blu-ray player, a personal computer, a tablet, a mobile phone, a stream media receiver, etc.) without an integrated display device, but may be embodied as an apparatus or device that includes an integrated display device, such as a television set or a monitor,. As such, a television signal receiver may a combination of the electronic device 20 and the display 30. Many television sets include the functions of the electronic device 20 and the display 30.

The user input device 10 is operative or configured to generate and output control signals that control the operation of the electronic device 20 and/or other devices, such as the display 30. According to an exemplary embodiment, the user input device 10 includes a plurality of input keys and outputs control signals in a wired and/or wireless (e.g., via infrared or radio frequency (RF) link, etc.) manner responsive to user depression of its input keys. The user input device 10 may for example be embodied as a hand-held remote control device, wired and/or wireless keyboard, integrated control panel of the electronic device 20, and/or other user input device.

The electronic device 20 is operative or configured to receive signals including audio, video and/or data signals having one or more types of analog modulation (e.g., NTSC, PAL, SECAM, etc.) and one or more types of digital modulation (e.g., QPSK, QAM, VSB, etc.) from one or more broadcast sources such as cable, terrestrial, satellite, internet and/or other signal sources and to provide aural/visual and/or visual only outputs corresponding to these received signals.

The electronic device 20 is operative or configured to allow instant, time-shift and timer recordings. Time-shift recording is a system that is used temporarily to store broadcast signals for later viewing, instant recording is a system for immediate recording and timer recording is a system that is used for predefined, later recording of media content.

The electronic device 20 is also operative or configured to process received signals and provide the resulting processed signals to one or more other devices, and to receive signals from other devices, such as but not limited to a DVD player, a VCR, a PVR, a HDR, a HVR, a Blu-ray player, or a storage device.

The electronic device 20 may be equipped with one or two detectors, such as but not limited to cameras (not shown), one viewing areas in front of the display 30 and the other viewing areas behind the display 30. According to the principles of the embodiments of the invention, the electronic device 20 is operative or configured to detect ambient lighting condition using one or both cameras; determine whether a stored display setting corresponding to the detected ambient light condition exists in a memory; if the corresponding stored display setting does not exist, request a user to enter a display setting as the corresponding stored display setting; and adjust display setting of the display 30 according to the corresponding stored display setting. The user entered display setting is stored in a memory as the displaying setting corresponding to the detected ambient light condition.

The electronic device 20 is further operative or configured to provide on-screen menus for users to enter the display setting. The electronic device 20 may display an on-screen menu in response to determining that a stored display setting corresponding to the detected ambient light condition does not exist in the memory.

In one embodiment, the electronic device 20 is operative or configured to allow a user to select whether to allow automatic selection of display setting according to different ambient lighting even if the corresponding display setting does not exist in the memory.

The display 30 may be any display, such as but not limited to LCD, OLED, electronic Ink, and plasmas, and the display may be a part of a TV, a PC, or another television signal receiver.

A display setting may include parameters such as but not limited to picture mode (e.g., standard, cinema, vivid), contrast or picture, brightness, color, tint, sharpness, and color temperature. For an LCD display, it may also include backlight adjustment and for a plasma display, it may include cell light adjustment. A television set normally has a default display setting, which should be the factory setting, and provides a way for a user to change the display setting. The television set renders a picture according the display setting using algorithms already included in the television set.

Referring to FIG. 2, a diagram providing further details of the electronic device 20 of FIG. 1 according to an exemplary embodiment of the present invention is shown. The electronic device 20 of FIG. 2 comprises front panel means such as front panel assembly (FPA) 21, amplifying means such as amplifier 22, and input/output (I/O) means such as I/O block 23, processing means such as processor 24, ambient lighting condition detector, such as a front camera 26 and/or a rear camera 27, and memory means such as memory 25. Some of the foregoing elements of FIG. 2 may be embodied using integrated circuits (ICs), and some elements may for example be included on one or more ICs. For clarity of description, certain conventional elements associated with the electronic device 20 such as certain control signals, power signals and/or other elements may not be shown in FIG. 2.

The FPA 21 is operative or configured to receive user inputs from the user input device 10, and to output signals corresponding to the user inputs to the amplifier 22. According to an exemplary embodiment, the FPA 21 receives signals, such as but not limited to IR and/or RF signals, from user input device 10 and generates corresponding signals which are output to the amplifier 22. The amplifier 22 is operative to amplify the signals provided from the FPA 21 for output to the processor 24.

The I/O block 23 is operative or configured to perform I/O functions of the electronic device 20. According to an exemplary embodiment, the I/O block 23 is operative to receive signals such as audio, video and/or data signals in analog and digital modulation formats from one or more broadcast signal sources such as cable, terrestrial, satellite, internet and/or other signal sources. Although not expressly shown in FIG. 2, the I/O block 23 may include a plurality of input terminals each designated to receive signals from a given broadcast signal source. For example, the I/O block 23 may include separate input terminals for receiving signals from cable, antenna (i.e., terrestrial), satellite, internet and/or other signal sources. The I/O block 23 is also operative to output processed signals to one or more other devices connected to the electronic device 20, and to receive signals from such devices. Devices connected to the electronic device 20 may include DVD players, VCRs, PVRs, HDRs, HVRs, Blu-ray players, and/or storage devices. The devices may be connected to the I/O block 23 in a wired and/or wireless manner.

The processor 24 is operative or configured to perform various signal processing and control functions of the electronic device 20. According to an exemplary embodiment, the processor 24 processes the audio, video and/or data signals provided from the I/O block 23 by performing functions including channel tuning, analog and digital demodulation, and other functions to thereby generate data representing audio, video and/or data content. The data produced from such processing functions may be provided for further processing (e.g., MPEG decoding, etc.) and output to be received by, for example, the display device 30. Also according to an exemplary embodiment, the processor 24 detects and processes user inputs provided via the user input device 10, and may control its own operations and/or output control signals to control other elements of the electronic device 20 (including elements not shown in FIG. 2) responsive to such user inputs.

The processor 24 is also operative or configured to execute software code that automatically detecting a condition of ambient lighting; determining whether a stored display setting corresponding to the detected ambient light condition exists in the memory 25; if the corresponding stored display setting does not exist, requesting a user to enter a display setting as the corresponding stored display setting; and adjusting display setting of a display according to the corresponding stored display setting. The processor 24 is also operative or configured to store the user entered display setting in the memory 25 as the corresponding stored display setting to the detected ambient light condition. If the user fails to enter the display setting within a predetermined interval, the processor 24 may use a displaying setting derived using a predetermined rule. For example, the processor 24 may just use the factory display setting, the current setting, or just setting color temperature to be the same as or similar to the detected front color temperature if the front color temperature is available and the detected rear color temperature, if the front color temperature is not available.

The processor 24 is also operative or configured to control the front camera 26 in order to detect at least the brightness and the color temperature of the ambient lighting condition in front of the display 30. The processor 24 may analyze still pictures or moving pictures captured by the front camera 26 periodically using a conventional method in order to obtain the information of brightness and color temperature. The brightness may be expressed as the luminous intensity. The processor 24 may be operative or configured to analyze the pictures captured by the front camera 26 to determine if a room lamp is on or off using a conventional image recognition method and use the room lamp status as part of the ambient lighting condition in front of the display 30 (the front ambient lighting condition) because the room lamp status has an effect on color quality as viewed by the viewer. The processor 24 may be operative or configured to analyze the pictures captured by the front camera 26 to determine if a window exists in the room using a conventional image recognition method and use the presence/absence of a window as part of the ambient lighting condition in front of the display 30 (the front ambient lighting condition) because the presence/absence of a window has an effect on color quality as perceived by the viewer.

In one embodiment, the front camera 26 and/or the rear camera 27 is a smart camera, which can communicate with the processor 24 wirelessly through for example a Wi-Fi link, or a Bluetooth link, or another wireless link. A user in this embodiment may detach one or both cameras and move them to a desired location for a better detection of the ambient lighting condition.

The ambient lighting condition may be just the ambient lighting condition in front of the display 30 (the front lighting condition), but it may include the ambient lighting condition at the back side of the display 30 (the rear ambient lighting condition) because the rear ambient lighting condition also has an effect on color quality as perceived by a viewer. As such, the processor 24 may also be operative or configured to control the rear camera 27 in order to detect at least the brightness and the color temperature of the ambient lighting condition at the back side of the display 30. The processor 24 may analyze still pictures or moving pictures captured by the rear camera 27 periodically using a conventional method in order to obtain the information of brightness and color temperature.

The processor 24 may be operative or configured to provide a user interface, for example, in the form of an on-screen display (OSD), for a user to enter whether only the front ambient lighting condition, or the rear ambient lighting condition, or both are used as the ambient lighting condition, if only the front ambient lighting condition is used as the ambient lighting condition, whether the room lamp status and window status be included. Furthermore, the OSD user interface may provide an option asking the user whether the electronic device 24 automatically adjusts the displaying setting according to the ambient lighting condition if there is no corresponding displaying setting stored in the memory 25.

Furthermore, since the perceptual effects in daytime and night are different, the processor 24 may store as part of the ambient lighting condition the time (e.g., daylight or night). The processor 24 may detect the time according to a real clock (not shown) in the electronic device 20 indicating the current time, as well known in the art.

The memory 25 is operative or configured to perform data storage functions of electronic device 20. According to an exemplary embodiment, memory 25 stores data including, but not limited to, software code, electronic program guide data, user preference data, recorded audio/video signals, recorded video only signals, and/or other data. The memory 25 may include volatile and/or non-volatile memory regions and storage devices such hard disk drives, DVD drives.

Referring now to FIG. 3, an exemplary process 300 for adjusting display setting of a display according to ambient lighting condition, according to the principles of the embodiments of the invention, is shown. For purposes of example and explanation only, the steps of FIG. 3 may be explained hereinafter with specific reference to the exemplary embodiments of FIGS. 1 and 2 described above. At step 305, the processor 24 of the electronic device 20 is operative or configured to detect condition of ambient lighting. As discussed above, the ambient lighting condition may be front ambient lighting condition, rear ambient lighting condition, or both. The ambient lighting condition includes information such as but not limited to color temperature and luminous intensity. Although the color temperature and luminous intensity may be obtained by the processor 24 analyzing still or motion pictures captured by a camera, they can be obtained by a set of color temperature sensor and a luminance sensor as well. The ambient lighting condition may also include room lamp status and/or whether the room includes a window. In the embodiment of FIG. 2, a camera is used and is preferred. The processor 24 may be configured and operative to detect the presence of a room lamp and/or the presence of a window by using conventional image processing process, such as but not limited to pattern recognition. The processor 24 may also be configured or operative to detect the on/off status of a room light by comparing the luminous intensity of the image of the room light with a threshold. If the luminous intensity is over the threshold, the processor 24 is configured and operative to determine that the room lamp is on; otherwise is off.

At step 310, the processor 24 is operative or configured to determine whether a stored display setting corresponding to the detected ambient light condition exists in the memory 25. FIG. 4 shows exemplary stored ambient lighting conditions when the ambient lighting condition is the front ambient lighting condition, each associated with a stored display setting (not shown) stored in the memory 25. Columns 410 and 420 are respectively the front ambient color temperature in the unit of Kelvin, having the unit symbol K, and the front luminous intensity having the unit of candela, having the unit symbol of cd. In FIG. 4, there are shown four front ambient lighting conditions, 471-474, each having a stored display setting (not shown). If the detected ambient lighting condition is the same as one of the four, a corresponding stored display setting in the memory 25 exists. In one embodiment, as long as the detected color temperature falls within a predefined range having the color temperature of a stored ambient lighting condition as the center point and the detected luminous intensity falls within a predefined range having the luminous intensity of the stored ambient lighting condition as the center point, the processor 24 is operative or configured to determine that the stored display setting of the stored ambient lighting condition corresponds to the detected ambient lighting condition. The predefined range of the color temperature may be defined as the color temperature of a stored display setting plus/minus a predetermined color temperature allowance, such as but not limited to 250K and the predefined luminous intensity range may be defined as the luminous intensity of the stored ambient lighting condition plus/minus a predetermined luminous intensity allowance, such as but not limited to 10 cd, An advantage of using the allowances is to reduce the number of interruptions that the processor 24 is required to process and configure different display settings responsive to different ambient lighting conditions. They also have the effect of reducing the number of interruptions to the viewing of the user. If the rear ambient lighting condition is used as the ambient lighting condition, the operations are similar.

FIG. 5 shows exemplary stored ambient lighting conditions when the ambient lighting condition is the combination of the front ambient and rear light conditions, each of the stored ambient lighting conditions associated with a stored display setting (not shown) stored in the memory 25. Columns 510, 520, 530, and 540 are the front ambient color temperature, the front luminous intensity, the rear ambient color temperature, the rear luminous intensity, respectively. In FIG. 5, there are shown four ambient lighting conditions, 571-574, each having a stored display setting (not shown). If the detected ambient lighting condition is the same as one of the four, a corresponding stored display setting in the memory 25 exists. In one embodiment, as long as the detected color temperature falls within a predefined range having the corresponding color temperature of a stored ambient lighting condition as the center point and the detected luminous intensity falls within a predefined range having the corresponding luminous intensity of the stored ambient lighting condition as the center point, the processor 24 are operative or configured to determine that the stored display setting of the stored ambient lighting condition corresponds to the detected ambient lighting condition. The ranges can be defined as those discussed previously with respect to FIG. 4. The ranges used for the rear lighting condition may be different from those used for the front lighting condition because the front lighting condition should have more visual impacts than the rear lighting condition.

FIG. 6 shows exemplary stored ambient lighting conditions when the ambient lighting condition includes the combination of the front and rear ambient light conditions, and one or more of the room lamp status (e.g., on/off of a room lamp), the window status (the presence/absence of a window), and time (e.g., morning, afternoon, daytime or night), each of the stored ambient lighting conditions associated with a stored display setting (not shown) stored in the memory 25. Columns 610, 620, 630, 640, 650, 660, and 665 are the front ambient color temperature, the front luminous intensity, the rear ambient color temperature, the rear luminous intensity, the room lamp status, the window status, and time (e.g., daytime or night), respectively. In FIG. 6, there are shown four front ambient lighting conditions, 671-674, each having a stored display setting (not shown).

If the detected ambient lighting condition is the same as one of the four, a corresponding stored display setting in the memory 25 exists. In one embodiment, although the room lamp status and the window status must be the same as those in a stored display setting, the processor 24 is operative or configured to determine that the stored display setting of the stored ambient lighting condition corresponds to the detected ambient lighting condition, as long as the detected color temperature falls within a predefined range having the corresponding color temperature of the stored ambient lighting condition as the center point and the detected luminous intensity falls within a predefined range having the corresponding luminous intensity of the stored ambient lighting condition as the center point, The ranges can be defined as those discussed previously with respect to FIGS. 4 and 5.

Although not illustrated in a drawing, the stored ambient lighting may include the front or rear ambient lighting condition, and/or one or more of the rear lighting condition, the room lamp status, the window status, and time. The room lamp status may include the status of one or more room lamps and the window status may include window status of one or more windows.

Note that it is possible that a detected ambient lighting condition may fall within the ranges of at least two entries of the stored display settings. In that scenario, the processor 24 selects the display setting associated with the entry that has the closest color temperature(s) or closest luminous intensity/intensities as the corresponding stored display setting. In another embodiment, the processor 24 selects the entry that has the shortest Euclidean distance to the detected ambient lighting condition. The processor 24 computes a Euclidean distance between each candidate entry and the detected ambient lighting condition and selects the entry that has the shortest

Euclidean distance as the corresponding stored display setting. In this embodiment, the off and off statuses of the room lamp respectively have values of 0 and 1, the absence and presence of the window respectively have values of 0 and 1, and daytime and night respectively have values of 0 and 1. For example, if the detected ambient lighting condition includes t K front ambient color temperature, u cod front luminous intensity, v K rear ambient color temperature, w rear luminous intensity, x room status, y window status and z time, the Euclidean distance between the entry 671 in FIG. 6 and the detected ambient lighting condition is the square root of the sum of the square of (t-2700), the square of (u-10), the square of (v-3000), the square of (w-100), the square of (x-0), the square of (y-0), and the square of (z-0). In another embodiment, the processor 24 is operative or configured to interpolate the display settings of the two closest entries and adjust the display setting of the display using the interpolated display setting.

In one embodiment, one or more parameters of the detected ambient lighting condition are adjusted by a weighting factor predefined by the user.

At step 315, if the corresponding stored display setting does not exist, the processor 24 is operative or configured to request a user to enter a display setting as the corresponding stored display setting. The processor 24 may be operative or configured to provide a user interface, for example, in the form of an on-screen display (OSD), asking the user to enter the corresponding display setting. The user entered display setting along with the detected ambient lighting condition is stored by the processor 24 as an additional entry to the database of stored display settings, such as but not limited to those shown in FIGS. 4-6.

The OSD menu may provide a default setting and the user may modify each parameter in the default setting to obtain the corresponding stored display setting. For example, FIG. 7 shows an exemplary OSD menu 700 including a contrast field 702, a brightness field 704, the color field 706, a tint field 708, a sharpness field 710, a color temperature 712, and a picture mode field 714. The default for each of the fields 702, 704, 706, 708, 710, and 712 is around 50%. The user may increase and decrease each of those fields by pressing the right and left arrow buttons in the remote control 10. Regarding the picture mode field, the default is STANDARD, and a user may use the right or left arrow button to cycle through CINEMA and VIVID. The user may instruct the processor 24 to store the entered displaying setting as the corresponding stored display setting by activating a particular button in the user input device 10 or selecting a button on the OSD menu.

If the user fails to enter the display setting within a predetermined interval, the processor 24 may use a displaying setting derived using a predetermined rule. For example, the processor 24 is operative or configured to use the default setting, which should be the factory setting or a current setting, or just set color temperature to be the same as or similar to the detected front color temperature if the front color temperature is available or the detected rear color temperature, if the front color temperature is not available. For example, the processor may be operative or configured to set the color temperature of the display to be the same or within a predefined range of the detected front or rear color temperature. However, the processor 24 does not store the automatically set display setting, so that when the processor 24 detects a similar ambient lighting condition, the processor 24 is operative or configured to request the user to enter a display setting as the corresponding stored display setting. In one embodiment, instead of presenting the default display setting, the processor 24 is operative or configured to present a display setting that includes the color temperature determined by the processor 24 using the predefined rule and the user is free to modify any parameter in the presented setting.

If the processor 24 is playing back a video, the processor 24, during the display of the OSD user interface, may allow the playback to continue or may interrupt the playback until the OSD user interface is removed, according to a user preference setting.

In one embodiment, the electronic device 20 provides a user interface, such as an OSD, for a user to clear one or more of the user entered display settings. When a user uses this interface to clear one of the user entered display settings, the corresponding ambient lighting condition is treated as a new ambient lighting condition and the processor 24 requests the user to enter a display setting for this ambient lighting condition when first encountered after the clearance.

In another embodiment, the electronic device 20 may provide a user interface to modify a stored display setting. This user interface displays all the stored display settings and the user is able to select one of them for modification.

At step 320, the processor 24 is operative or configured to adjust the display setting of a display according to the corresponding stored display setting. The rendering of a picture or video according to the new display setting is done by the electronic device 20 according to conventional image processing techniques already included in the electronic device 20.

As an example, if the electronic device 20 is a television set, the television set on a store includes only a default display setting, which may be a factory setting best suited for ambient lighting conditions in a store. When the user brings a new television set home and turns on the television set, the television set detects a new ambient lighting condition, which is different from the store. When the user turns on a room lamp, the television set detects yet another different ambient lighting condition. In either case, the television set is operative or configured to determine whether a stored display setting corresponding to the detected ambient light condition exists in the memory 25. If the corresponding stored display setting does not exist, the television set is operative or configured to request a user to enter a display setting as the corresponding stored display setting. At some point, display settings for all the ambient lighting conditions are entered by the user, and the television set can automatically adjust the display according a corresponding stored display setting. As discussed above, the television may provide the user a user interface to modify or clear a user entered display setting.

While this invention has been described using exemplary embodiments, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A method for adjusting a display setting of a display comprising:
detecting an ambient lighting condition;
determining whether a stored display setting corresponding to the detected ambient lighting condition exists in a memory;
if the corresponding stored display setting does not exist, requesting a user entry of a display setting as the corresponding stored display setting; and
adjusting the display setting of the display according to the corresponding stored display setting; wherein the detected ambient lighting condition includes an ambient lighting condition collected at a back side of the display and an ambient lighting condition collected at a front side of the display.

2. The method of claim 1, further comprising storing the entered display setting in the memory as the corresponding stored display setting.

3. The method of claim 1, wherein the detected ambient lighting condition includes color temperature and luminous intensity.

4. The method of claim 3, wherein the detected ambient lighting condition further includes on/off status of a lamp.

5. (canceled)

6. The method of claim 3, wherein the detected ambient lighting condition includes current time.

7. The method of claim 1, wherein if the user fails to enter a display setting in response to the requesting step, the method further comprises setting automatically by an electronic device a display setting according to a predefined rule as the corresponding stored display setting.

8. The method of claim 7, wherein the automatically set display setting is not stored in the memory as the corresponding stored display setting and is used to adjust the display setting of the display.

9. The method of claim 7, wherein the predefined rule is to use a default display setting as the corresponding stored display setting.

10. The method of claim 7, wherein the detected ambient lighting condition includes condition collected at a front side of the display, the lighting condition collected at the front side includes first color temperature, and the predefined rule is to use a display setting having color temperature similar to the first color temperature as the corresponding stored display setting.

11. The method of claim 1, wherein the requesting comprises displaying an on-screen display menu for the user to enter the display setting.

12. The method of claim 11, wherein the on-screen display menu includes a default display setting.

13. An electronic device comprising:
a detector configured to detect an ambient lighting condition;
a processor configured to determine whether a stored display setting corresponding to the detected ambient lighting condition exists in a memory;
wherein if the corresponding stored display setting does not exist, the processor is configured to request a user entry of a display setting as the corresponding stored display setting; and
wherein the processor is configured to adjust the display setting of a display according to the corresponding stored display setting; wherein the detected ambient lighting condition includes an ambient lighting condition collected at a back side of the display and an ambient lighting condition collected at a front side of the display.

14. The electronic device of claim 13, wherein the processor is configured to store the entered display setting in the memory as the corresponding stored display setting.

15. The electronic device of claim 13, wherein the detected ambient lighting condition includes color temperature and luminous intensity.

16. The electronic device of claim 15, wherein the detected ambient lighting condition further includes on/off status of a lamp.

17. (canceled)

18. The electronic device of claim 15, wherein the detected ambient lighting condition includes current time.

19. The electronic device of claim 13, wherein if the user fails to enter display setting in response to the requesting step, the processor is configured to automatically set display setting according to a predefined rule as the corresponding stored display setting.

20. The electronic device of claim 19, wherein the automatically set display setting is not stored in the memory as the corresponding stored display setting and the processor is configured to adjust the display setting of the display using the automatically set display setting.

21. The electronic device of claim 19, wherein the predefined rule is to use a default display setting as the corresponding stored display setting.

22. The electronic device of claim 19, wherein the detected ambient lighting condition includes condition collected at a front side of the display, the lighting condition collected at the front side includes first color temperature, and the predefined rule is to use a display setting having color temperature similar to the first color temperature as the corresponding stored display setting.

23. The electronic device of claim 13, wherein the processor is configured to request the user to enter a display setting by displaying an on-screen display menu.

24. The electronic device of claim 23, wherein the on-screen display menu includes a default display setting.

25-36. (canceled)
